(19) United States
(12) Patent Application Publication
(10) Pub. No.: US 2018/0034081 A1
(43) Pub. Date: Feb. 1, 2018

(54) ELECTROLYTIC STORAGE OF HYDROGEN

(71) Applicant: Rodolfo Antonio Gomez, Brompton (AU)

(72) Inventor: Rodolfo Antonio Gomez, Brompton (AU)

(21) Appl. No.: 15/552,800

(22) PCT Filed: Dec. 21, 2015
(86) PCT No.: PCT/AU2015/000758

§ 371 Date: Aug. 22, 2017

(30) Foreign Application Priority Data
Feb. 23, 2015 (AU) 2015900617
Apr. 7, 2015 (AU) 2015901232
Oct. 15, 2015 (AU) 2015101511

(51) Int. Cl. H01M 8/04082; C01B 3/00; C25B 1/04; H01M 8/0656; C25B 9/08; C25B 9/06

(52) U.S. Cl. CPC H01M 8/04201; C25B 9/08; C25B 9/06; C25B 1/04; H01M 8/0656; C01B 3/0005

(57) ABSTRACT

A process and apparatus where unipolar electrolysis is used to remove the electron from the hydrogen gas and the proton is stored in a very small volume in a high surface area electrode or in a conducting aqueous or non-aqueous conductive liquid containing fine particles of hydrogen receptors and unipolar electrolysis is used to add electrons to the hydrogen proton to produce the hydrogen gas when it is required as a fuel. The process and apparatus have applications in electric power generation from renewable energy and the use of hydrogen in land, water and air vessels.

### PRIORITY DOCUMENTS

The present application claims priority from the following applications:
Australian Provisional Patent Application No. 2015900617 titled “Electrolytic Storage of Hydrogen and Oxygen” filed on 23 Feb. 2015;
Australian Provisional Patent Application No. 2015901232 titled “Hydrogen Storage in Metal Particles or Ions in a Liquid” and filed on 7 Apr. 2015; and
Australian Innovation Patent No. 2015101511 titled “Electrolytic Storage of Hydrogen” and filed on 15 Oct. 2015.

The contents of each of these documents are hereby incorporated by reference in their entirety.

### INCORPORATION BY REFERENCE

The following publications are referred to in the present application and their contents are hereby incorporated by reference in their entirety:
U.S. Pat. No. 7,326,329 “Commercial Production of Hydrogen from Water” in the name of Rodolfo Antonio M. Gomez;
U.S. Pat. No. 6,475,653 “Non-diffusion Fuel Cell and a Process of Using a Fuel Cell” in the name of RMG Services Pty Ltd; and
U.S. Pat. No. 5,882,502 “Electrochemical System and Method” in the name of RMG Services Pty Ltd.

### TECHNICAL FIELD

The present invention relates to the electrolytic storage of hydrogen as a proton and the recovery of the proton as hydrogen gas as fuel for hydrogen fuel cells.

### BACKGROUND

To meet the World's requirement for clean renewable energy, the present applicant has shown that hydrogen can be produced by the unipolar electrolysis of water as described in U.S. Pat. No. 7,326,329 (“Unipolar electrolysis”). In unipolar electrolysis, theoretically 6.13 times more hydrogen is produced from the same energy to produce 1 mole of hydrogen as compared to the conventional electrolysis of water. Also, U.S. Pat. No. 6,475,653 describes an efficient and scalable fuel cell that will allow clean electrical energy and transport energy to be derived from renewable energy sources, such as solar and wind.

To complete the economical use of hydrogen for continuous electric power generation and for transport energy, a method is required to store large quantities of hydrogen economically so that the hydrogen fuel can be economically used for land transport vehicles, sea transport vessels and air transport vessels. Economical and practical methods of storing energy are also required for renewable energy, such as solar and wind, to enable electricity to be delivered continuously.

Hydrogen can be stored and recovered by compressing the gas but, even at very high pressure, the amount of hydrogen stored is not sufficient to provide storage for a reasonable range of transport vehicles. The high pressure also creates problems of safety and the weight of the container housing the compressed hydrogen gas is also a problem.

Advances have been made in storing hydrogen in metal hydride alloys and, more recently, the use of alloys of rare earth elements such as lanthanum-nickel alloys. The Shanghai Astronomical Observatory of the Chinese Academy of Sciences has estimated that 1 kilogram of lanthanum nickel alloy (LaNi₅) can store 153 litres of hydrogen at 2-3×10⁵ Pascals of pressure. To recover the hydrogen, heating is required and this is a major disadvantage of this process. FIG. 1 herein provides data from the China Hydrogen Fuel Cell R&D Centre for the comparative storage of 4 kilograms of hydrogen in several different media compared to the size of a motor vehicle. The best storage for the 4 kilograms of hydrogen is 44 litres of magnesium nickel hydride.

Better systems and processes for the storage of hydrogen are required to advance the use of hydrogen as a clean fuel.

### SUMMARY

The present disclosure is based on the fact that hydrogen gas has a volume of 22.4 litres per mole or per 2 grams of hydrogen at standard temperature and pressure but the hydrogen proton has a volume of only 4.2×10⁻⁴⁵ cubic metre or 4.2×10⁻⁴² litres (Table 1). There are 6.022×10⁻²³ protons in 1 gram of hydrogen. The volume of 1 gram of hydrogen proton is (6.022×10²³×4.2×10⁻⁴²)=2.52924×10⁻¹⁸ litres. The volume of 4 kilograms of hydrogen protons is 1.012×10⁻¹⁴ litres. The data shows there is a very large difference in the volumes of hydrogen gas and the hydrogen proton.

TABLE 1

| Properties of hydrogen protons | | |
|---|---|---|
| Volume of single Hydrogen proton (m³) | 4.2 × | 10⁻⁴⁵ |
| Volume of single Hydrogen proton (L) | 4.2 × | 10⁻⁴² |
| Number of protons in 1 mole | 6.02 × | 10²³ |
| Volume of 1 mole of proton (L) | 2.53 × | 10⁻¹⁸ |
| Weight of 1 mole of proton (grams) | 1.0 | |
| Volume of 2 mole of proton (L) | 5.06 × | 10⁻¹⁸ |
| Weight of 2 mole of proton (grams) | 2.0 | |
| Volume of 4 kilograms of proton (L) | 1.012 × | 10⁻¹⁴ |

To make full use of this scientific fact, a process is required to remove electrons from hydrogen gas for storage as hydrogen protons and add electrons to the hydrogen protons when hydrogen gas is required.

The storage of the oxygen ion is more complex as the ion contains 8 protons and 8 neutrons. The volume of 2 moles of oxygen ions (64 grams) is 0.010 litres and the volume of 1 mole liquid oxygen is 0.028 litres at −183° C. It may be more practical to use liquid oxygen as discussed below and storage of hydrogen proton and using liquid oxygen is a practical combination.

TABLE 2
Properties of oxygen

| Calculated volume | O²⁻ | | O | |
|---|---|---|---|---|
| Radius (m) | 1.26 × | 10⁻¹⁰ | 7.3 × | 10⁻¹¹ |
| Volume (m³) | 8.38 × | 10⁻³⁰ | 1.63 × | 10⁻³⁰ |
| Volume (L) | 8.38 × | 10⁻²⁷ | 1.63 × | 10⁻²⁷ |
| Number of O²⁻ in 1 mole Oxygen | 1.2 × | 10²⁴ | 1.2 × | 10²⁴ |
| Mole volume of 1 mole (m³) | 1.01 × | 10⁻⁵ | 1.96 × | 10⁻⁶ |
| Mole volume of 1 mole (L) | 1.01 × | 10⁻² | 1.01 × | 10⁻³ |
| Mole volume of 1 kilogram of | 0.315625 | | | |
| Oxygen ions (L) | | | | |
| Real Volume | | | | |

| | |
|---|---|
| Liquid Oxygen (kg/L) | 1.141 |
| 1 mole (32 grams) of liquid oxygen (L) | 0.0279965 |

In a first aspect, the present disclosure provides a process for storing hydrogen as a proton, the process comprising:
providing an electrolytic cell comprising an anode cell having an anode electrode and a cathode cell having a cathode electrode, the anode cell and the cathode cell being electrically connected via a diaphragm or electronic membrane between the anode cell and the cathode cell or via an anode solution electrode in the anode cell connected by an external conductor to a cathode solution electrode in the cathode cell;
feeding hydrogen to the anode cell and applying a DC current from a DC power source to the anode electrode to generate hydrogen protons from the hydrogen gas in the anode cell;
storing the generated hydrogen protons in a hydrogen proton storage medium; and
feeding oxygen to the cathode cell and applying a DC current from the DC power source to the cathode electrode to generate oxygen anions from the oxygen gas in the cathode cell and storing the generated oxygen anions, or
feeding hydrogen to the cathode cell and applying a DC current from the DC power source to the cathode solution electrode to generate hydrogen protons from the hydrogen gas in the cathode cell and storing the generated hydrogen protons in a hydrogen proton storage medium.

In certain embodiments of the first aspect, the hydrogen proton storage medium is an electrode with high surface area and/or a conducting aqueous or non-aqueous conductive liquid that contains hydrogen proton receptors comprising metal ions, particles of metal alloys, a metal coated with another metal, or an activated carbon particle infused with metal oxides and reduced by hydrogen.

In certain embodiments of the first aspect, the process further comprises generating hydrogen gas from the hydrogen protons by changing the electrical circuit so that electrons are added to the anode electrode and/or the cathode electrode under conditions to form hydrogen gas from the hydrogen protons.

In certain embodiments of the first aspect, the anode cell comprises a conductive gel between the anode electrode and the anode solution electrode and/or the cathode cell comprises a conductive gel between the cathode electrode and the cathode solution electrode.

In certain embodiments of the first aspect, the process further comprises feeding the hydrogen gas produced to a non-diffusion hydrogen fuel cell to produce electricity.

In certain embodiments of the first aspect, the hydrogen that is fed to the cell(s) is produced by unipolar electrolysis of water.

In a second aspect, the present disclosure provides an apparatus to store hydrogen as a proton, the apparatus comprising a diaphragm-less anode cell to produce hydrogen protons from hydrogen wherein the anode cell has an anode electrode and an anode solution electrode, the anode electrode being connected to a DC power source, a diaphragm-less cathode cell to produce hydrogen protons from hydrogen wherein the cathode cell has a cathode electrode and a cathode solution electrode, the cathode being connected to a DC power source, the anode solution electrode connected to the cathode solution electrode by an external conductor, means to apply a DC current from the DC power source to the anode electrode and the cathode electrode to produce hydrogen protons, and a hydrogen proton storage medium for storing the generated hydrogen protons.

In certain embodiments of the second aspect, the hydrogen proton storage medium comprises an electrode with high surface area and/or a conducting aqueous or non-aqueous conductive liquid that contains hydrogen proton receptors comprising metal ions, particles of metal alloys, a metal coated with another metal, or an activated carbon particle infused with metal oxides and reduced by hydrogen.

In certain embodiments of the second aspect, the apparatus further comprises means for generating hydrogen gas from the hydrogen protons by changing the electrical circuit so that electrons are added to the anode electrode and the cathode electrode under conditions to form hydrogen gas from the hydrogen protons.

In certain embodiments of the second aspect, the anode cell comprises a conductive gel between the anode electrode and the anode solution electrode and/or the cathode cell comprises a conductive gel between the cathode electrode and the cathode solution electrode.

In certain embodiments of the second aspect, the apparatus further comprises a non-diffusion hydrogen fuel cell configured to produce electricity from the hydrogen gas produced.

In certain embodiments of the second aspect, the apparatus further comprises a unipolar water electrolysis apparatus configured to produce hydrogen to be fed to the cell(s).

### BRIEF DESCRIPTION OF DRAWINGS

Embodiments of the present invention will be discussed with reference to the accompanying drawings wherein:

FIG. 1 is a schematic diagram showing the comparative volume of 4 kilograms of hydrogen stored in different ways (data obtained from China Fuel Cell R&D Centre);

FIG. 2 shows schematic diagrams showing the electrolytic storage of H₂ and O₂ (FIG. 2A) and the electrolytic recovery of H₂ and O₂ (FIG. 2B) using diaphragm electrolytic cells;

FIG. 3 shows schematic diagrams showing the electrolytic storage of H₂ and O₂ (FIG. 3A) and the electrolytic recovery of H₂ and O₂ (FIG. 3B) using diaphragm-less electrolytic cells;

FIG. 4 shows schematic diagrams showing the electrolytic storage of H₂ (FIG. 4A) and the electrolytic recovery of H₂ (FIG. 4B) using diaphragm-less electrolytic cells;

FIG. 5 shows schematic diagrams showing the electrolytic storage of H₂ (FIG. 5A) and the electrolytic recovery of H₂ (FIG. 5B) using a gel in unipolar cells;

FIG. 6 shows schematic diagrams showing hydrogen proton receptors in a liquid;

FIG. 7 shows schematic diagrams showing conceptually hydrogen protons attaching to a metal particle or ions. FIG. 7A depicts hydrogen protons attached to a magnesium nickel alloy, FIG. 7B depicts hydrogen protons attached to magnesium metal coated with nickel metal, and FIG. 7C depicts hydrogen protons attached to magnesium and nickel ions;

FIG. 8 is a schematic diagram showing conceptually hydrogen protons clustered around a Mg₂Ni₆Co₄H₆ carbon particle;

FIG. 9 shows schematic diagrams of an apparatus for electrolytic storage of H₂ (FIG. 9A) and the electrolytic recovery of H₂ (FIG. 9B);

FIG. 10 is a schematic diagram showing the application of hydrogen proton storage in renewable energy power generation;

FIG. 11 is a schematic diagram showing a hydrogen fuel cell vehicle;

FIG. 12 is a schematic diagram showing commercial hydrogen fuel cell operations;

FIG. 13 is a schematic diagram showing a hydrogen ion liquid and non-diffusion fuel cell for transport vehicles;

FIG. 14 is a schematic diagram showing a submarine powered by hydrogen fuel cell(s) as disclosed herein; and

FIG. 15 is a schematic diagram showing a jet liner powered by hydrogen and oxygen as disclosed herein.

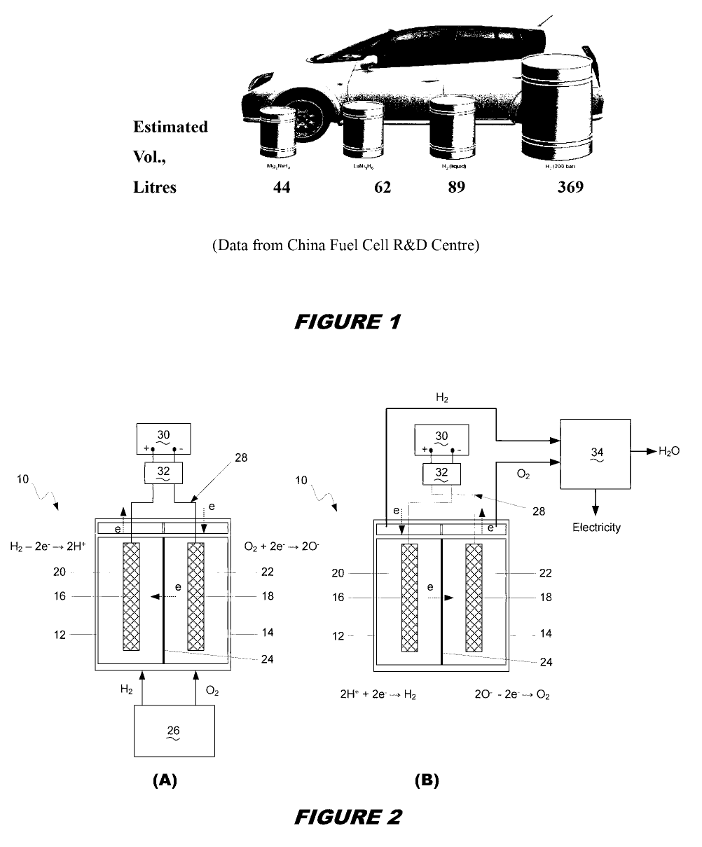

### DESCRIPTION OF EMBODIMENTS

Provided herein is a process for storing hydrogen as a proton. The process comprises:
providing an electrolytic cell 10 comprising an anode cell 12 having an anode electrode 16 and a cathode cell 14 having a cathode electrode 18, the anode cell 12 and the cathode cell 14 being electrically connected via a diaphragm or electronic membrane 24 between the anode cell and the cathode cell or via an anode solution electrode 34 in the anode cell 12 connected by an external conductor 38 to a cathode solution electrode 36 in the cathode cell 14;
feeding hydrogen to the anode cell 12 and applying a DC current from a DC power source 30 to the anode electrode 16 to generate hydrogen protons from the hydrogen gas in the anode cell 12;
storing the generated hydrogen protons in a hydrogen proton storage medium; and
feeding oxygen to the cathode cell 14 and applying a DC current from a DC power source 30 to the cathode electrode 18 to generate oxygen anions from the oxygen gas in the cathode cell 14 and storing the generated oxygen anions, or
feeding hydrogen to the cathode cell 14 and applying a DC current from a DC power source 30 to the cathode solution electrode 36 to generate hydrogen protons from the hydrogen gas in the cathode cell 14 and storing the generated hydrogen protons in a hydrogen proton storage medium.

FIG. 2 is a schematic diagram of a process of the present disclosure based on the storage and recovery of hydrogen and oxygen using a diaphragm or membrane type electrolytic cell 10. The cell 10 comprises an anode cell 12 and a cathode cell 14. The anode cell 12 comprises an anode electrode 16 and an acid electrolyte 20. The cathode cell 14 comprises a cathode electrode 18 and an alkaline electrolyte 22. The anode cell 12 and cathode cell 14 are separated by a diaphragm or electronic membrane 24. The structure and materials of components 12 to 24 can be any of those known to the skilled person. In use, hydrogen is loaded into the anode cell 12 and electrons are removed from the hydrogen gas producing hydrogen protons as shown in FIG. 2A. The hydrogen protons are stored in a hydrogen proton storage medium in the anode cell 12. The hydrogen proton storage medium may be any one or more of the following:
An electrode 16 constructed from a very high surface area material such as expanded metal, gauze, sponge or sintered fine metal powders and made up of or coated with a material that attracts hydrogen, such as magnesium-nickel-cobalt hydride;
An electrolyte 20 that is an aqueous or non-aqueous conductive liquid that holds hydrogen protons; and/or
An electrolyte 20 that contains ions, or fine particles of alloys of magnesium-nickel and cobalt hydride that hold the hydrogen protons.

Oxygen is loaded into the cathode cell 14 and electrons are added to the oxygen converting it to oxygen ions. The oxygen ions are stored in the electrolyte 22.

The hydrogen and oxygen can be produced or provided using any known method. In the illustrated embodiments, the hydrogen and oxygen are produced by unipolar electrolysis of water using electrolysis apparatus 26 as described in U.S. Pat. No. 7,326,329.

The electrolytic cell 10 also comprises an electrical circuit 28 comprising a DC power source 30 and modulator 32 in electrical connection with the electrodes 16 and 18. The circuit 28, DC power source 30 and modulator 32 can be formed from materials known in the art.

To recover the hydrogen as a gas, the electrical circuit 28 is changed so that electrons are added to the hydrogen proton as shown in FIG. 2B. Similarly, electrons are removed from the oxygen ion to form oxygen gas. The hydrogen gas and oxygen gas produced are then fed to a non-diffusion hydrogen fuel cell 34 to produce electricity and water as a by-product. The non-diffusion hydrogen fuel cell 34 can be any suitable cell, such as the one described in U.S. Pat. No. 6,475,653.

Thus, the present disclosure provides a process for storing hydrogen as a proton. The process comprises: providing an electrolytic cell 10 comprising an anode cell 12 having an anode electrode 16 and a cathode cell 14 having a cathode electrode 18 with a diaphragm or electronic membrane 24 between the anode cell 12 and the cathode cell 14. The anode electrode 16 and cathode electrode 18 are connected to a DC power source 30. In the illustrated embodiments, a single DC power source 30 is shown. However, it will be appreciated that each electrode 16 and 18 may also be connected to separate DC power sources. Hydrogen is fed to the anode cell 12 and a DC current is applied from the DC power source 30 to the anode electrode 16 and the cathode electrode 18 to generate hydrogen protons from the hydrogen gas in the anode cell 12. The generated hydrogen protons are stored in a hydrogen proton storage medium.

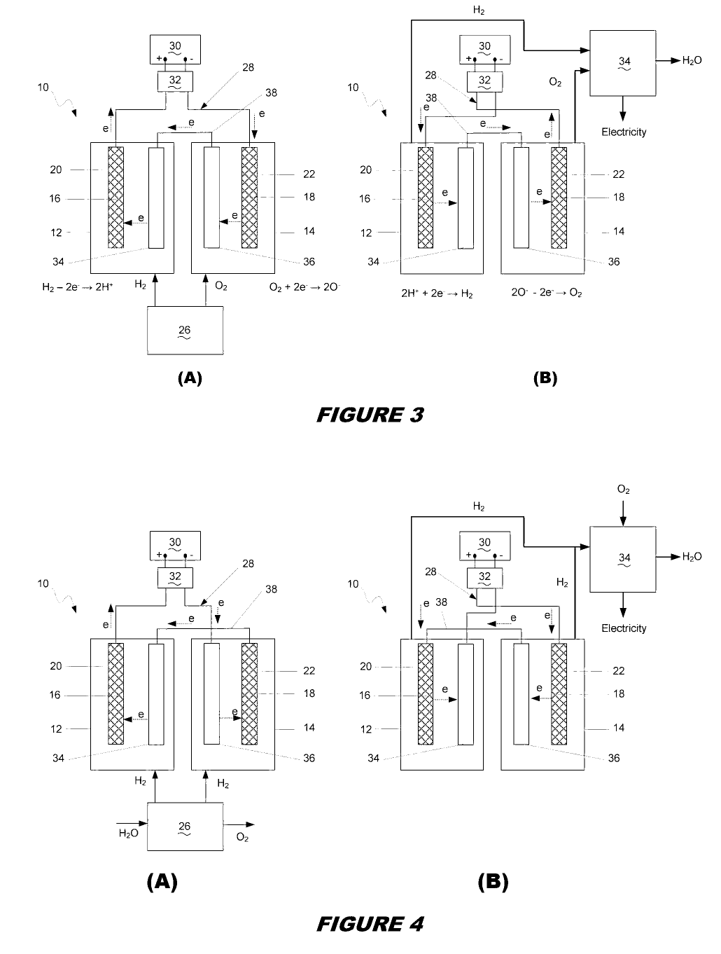

FIG. 3 shows the electrolytic storage and recovery of the hydrogen and oxygen carried out using a diaphragm-less electrolytic cell 10 based on U.S. Pat. No. 5,882,502. The cell 10 comprises an anode cell 12 and a cathode cell 14. The anode cell 12 comprises an anode electrode 16, an anode solution electrode 34 and an acid electrolyte 20. The cathode cell 14 comprises a cathode electrode 18, a cathode solution electrode 36 and an alkaline electrolyte 22. As shown in FIG. 3A, hydrogen gas is fed into the anode cell 12 and electrons are removed from the hydrogen to produce the hydrogen proton. The hydrogen proton may be stored in a hydrogen proton storage medium in the anode cell 12. The hydrogen proton storage medium may be any one or more of the following:
An electrode 16 constructed from a very high surface area material such as expanded metal, gauze, sponge or sintered fine metal powders and made up of or coated with a material that attracts hydrogen, such as magnesium-nickel-cobalt hydride;
An electrolyte 20 that is an aqueous or non-aqueous conductive liquid that holds hydrogen protons; and/or
An electrolyte 20 that contains ions, or fine particles of alloys of magnesium-nickel and cobalt hydride that hold the hydrogen protons.

Oxygen is loaded into the cathode cell 14 and electrons are added to the oxygen converting it to oxygen ions. The oxygen ions are stored in the electrolyte 22.

The hydrogen and oxygen can be produced or provided using any known method. In the illustrated embodiments, the hydrogen and oxygen are produced by unipolar electrolysis of water using electrolysis apparatus 26 as described in U.S. Pat. No. 7,326,329.

The electrolytic cell 10 also comprises an electrical circuit 28 comprising a DC power source 30, a modulator 32, the anode solution electrode 34 and the cathode solution electrode 36 in electrical connection with the electrodes 16 and 18. The circuit 28, DC power source 30, modulator 32 and solution electrodes 34 and 36 can be formed from materials known in the art.

To recover the hydrogen as a gas, the electrical circuit 28 is changed so that electrons are added to the hydrogen proton a shown in FIG. 3B. Similarly, electrons are removed from the oxygen ions to form oxygen gas. The hydrogen gas and oxygen gas are then fed to a non-diffusion hydrogen fuel cell 34 to produce electricity and water as a by-product. The non-diffusion hydrogen fuel cell 34 can be any suitable cell, such as the one described in U.S. Pat. No. 6,475,653.

Thus, the present disclosure provides a process for storing hydrogen as a proton. The process comprises feeding hydrogen to a diaphragm-less anode cell 12 wherein the anode cell 12 has an anode electrode 16 and an anode solution electrode 34. The anode electrode 16 is connected to a DC power source 30. Oxygen is fed to a diaphragm-less cathode cell 14 wherein the cathode cell 14 has a cathode electrode 18 and a cathode solution electrode 36. The cathode electrode 18 is connected to the DC power source 30. The anode solution electrode 34 is connected to the cathode solution electrode 36 by an external conductor 38. A DC current is applied from the DC power source 30 to the anode electrode 16 and the cathode electrode 18 to generate hydrogen protons from the hydrogen gas in the anode cell 12 and oxygen anions from the oxygen gas in the cathode cell 14. The generated hydrogen protons are stored in a hydrogen proton storage medium comprising the electrode 16 with high surface area and/or a conducting aqueous or non-aqueous conductive liquid 20 that contains hydrogen proton receptors comprising metal ions, particles of metal alloys, a metal coated with another metal, or an activated carbon particle infused with metal oxides and reduced by hydrogen.

In some embodiments, oxygen generated during unipolar electrolysis of water can be vented to the atmosphere and the hydrogen generated can be used for electric power generation and powering land vehicles and water surface vessels. In these applications, unipolar electrolysis is used to store the hydrogen as shown in FIG. 4. As shown in FIG. 4A, electrons are removed from the hydrogen as it is fed into the anode 12 and cathode cells 14. The hydrogen proton may be stored in a hydrogen proton storage medium in the anode 12 and cathode cells 14. The hydrogen proton storage medium may be any one or more of the following:
An electrode 16 constructed from a very high surface area material such as expanded metal, gauze, sponge or sintered fine metal powders and made up of or coated with a material that attracts hydrogen, such as magnesium-nickel-cobalt hydride;
An electrolyte 20 that is an aqueous or non-aqueous conductive liquid that holds hydrogen protons; and/or
An electrolyte 20 that contains ions, or fine particles of alloys of magnesium-nickel and cobalt hydride that hold the hydrogen protons.

The oxygen produced in the unipolar electrolysis of water can be discharged to the atmosphere.

The details of the components of the electrolytic cell 10 shown in FIG. 4 are the same as those shown in FIG. 3.

Thus, the present disclosure provides a process for storing hydrogen as a proton. The process comprises feeding hydrogen to a diaphragm-less anode cell 12 wherein the anode cell 12 has an anode electrode 16 and an anode solution electrode 34. The anode electrode 16 is connected to a DC power source 30. Hydrogen is also fed to a diaphragm-less cathode cell 14 wherein the cathode cell 14 has a cathode electrode 18 and a cathode solution electrode 36. The anode electrode 16 and the cathode solution electrode 36 are connected to the DC power source 30. The anode solution electrode 34 is connected to the cathode electrode 18 by an external conductor 38. A DC current is applied from the DC power source 30 to the anode electrode 16 and the cathode solution electrode 36 to generate hydrogen protons from the hydrogen gas in the anode cell 12 and the cathode cell 14. The generated hydrogen protons are stored in a hydrogen proton storage medium comprising the electrodes 16 and 18 with high surface area and/or a conducting aqueous or non-aqueous conductive liquids 20 and 22 that contain hydrogen proton receptors comprising metal ions, particles of metal alloys, a metal coated with another metal, or activated carbon particles infused with metal oxides and reduced by hydrogen.

In the hydrogen recovery shown in FIG. 4B, the electrical circuit 28 is changed so that electrons are added to the hydrogen proton via the anode solution electrode 34 and the cathode electrode 18. The hydrogen gas from the anode cell 12 and the cathode cell 14 is then fed to the non-diffusion hydrogen fuel cell 34 to produce electricity and water as a by-product. Oxygen is accessed from the atmosphere for the fuel cell reaction. As the fuel cell operates at no more 250° C., there is no chance of forming harmful nitrous oxide so that the waste product of the fuel cell 34 is water.

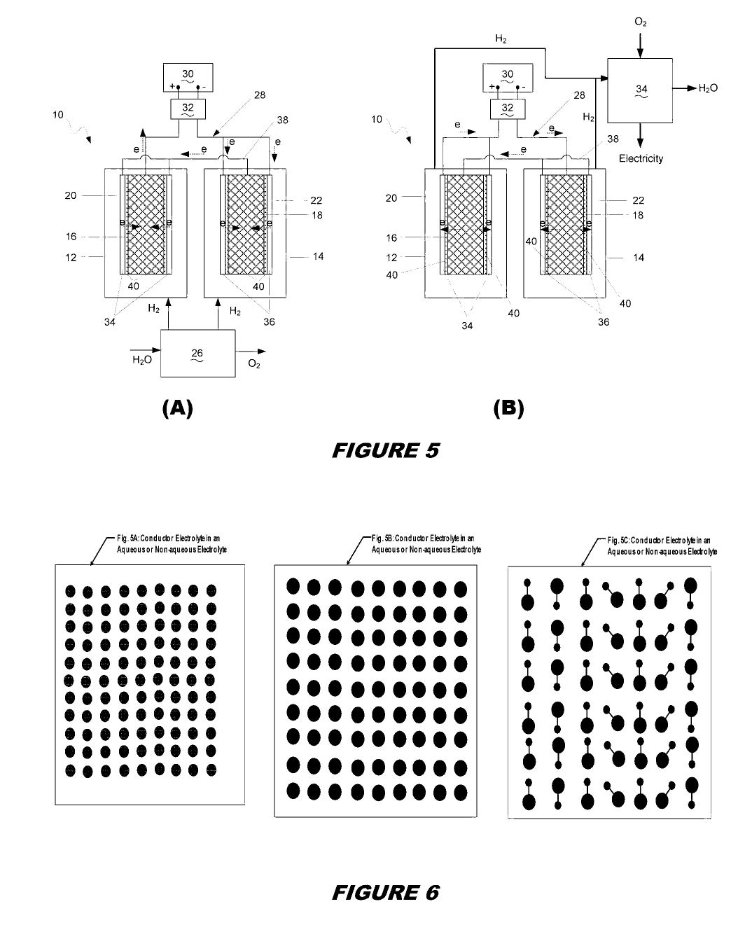

An alternative apparatus 10 is shown in FIG. 5. The apparatus 10 uses an acidic conductive gel 40 to connect the electrodes 16 and 18 in unipolar mode. The electrodes 16 and 18 are constructed of high surface area materials such as expanded metal, gauze, sponge or fine metal powder sintered together and made of alloys or coatings of magnesium nickel cobalt hydride. The hydrogen proton is stored on or in the surface of the electrodes 16 and 18. During storage as shown in FIG. 5A, electrons are removed from the hydrogen gas and the protons are stored on the surface of the electrodes 16 and 18. During recovery as shown in FIG. 5B, electrons are added to the protons at the electrodes to produce hydrogen gas.

The liquids that may be used to store the hydrogen proton include: aqueous liquids, such as solutions of sulfuric or phosphoric acid and weaker acids such as boric acid; and conducting non-aqueous conductive liquids.

Aqueous liquids increase their acidity as more hydrogen protons are dissolved in the liquid and this limits the amount of hydrogen protons that can be stored.

Conducting non-aqueous liquids may be able to dissolve a greater amount of hydrogen protons. According to Andreas Heintz, Department of Physical Chemistry, University of Rostock, Rostock, Germany (15 Apr. 2005), non-aqueous liquids are mixtures of ionic liquids with organic solvents. These have applications in electrically conductive liquids in electrochemistry.

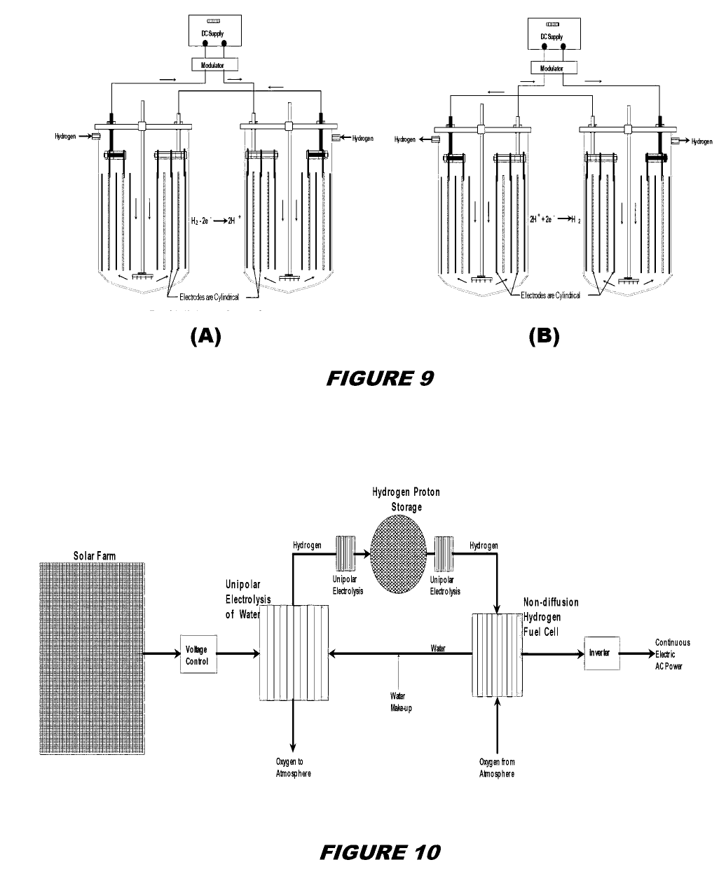

There are many potential conducting non-aqueous liquids that can be used, such as sulfolane, 1-n-butyl-2,3-dimethylimidazolium tetra-fluoroborate, and 1-n-butyl-2,3-dimethylimidazolium hexafluorophosphate. Potential non-aqueous liquids can be trialed in the apparatus shown in FIG. 9.

Hydrogen is attracted to metals such as magnesium nickel cobalt hydride. Therefore, the hydrogen proton will have greater attraction to these metals. One way to increase the proton storage capacity of a liquid is to add hydrogen proton carriers such as:
Metal ions in the liquid;
Metal alloy particles in the liquid;
Metal particles coated with another metal; and/or
Activated carbon particles infused with metal alloys.

FIG. 6 shows metal alloy particles in a conductive liquid in FIG. 6A, metal particles coated with another metal in a conductive liquid in FIG. 6B and FIG. 6C shows metal ions in a conductive liquid.

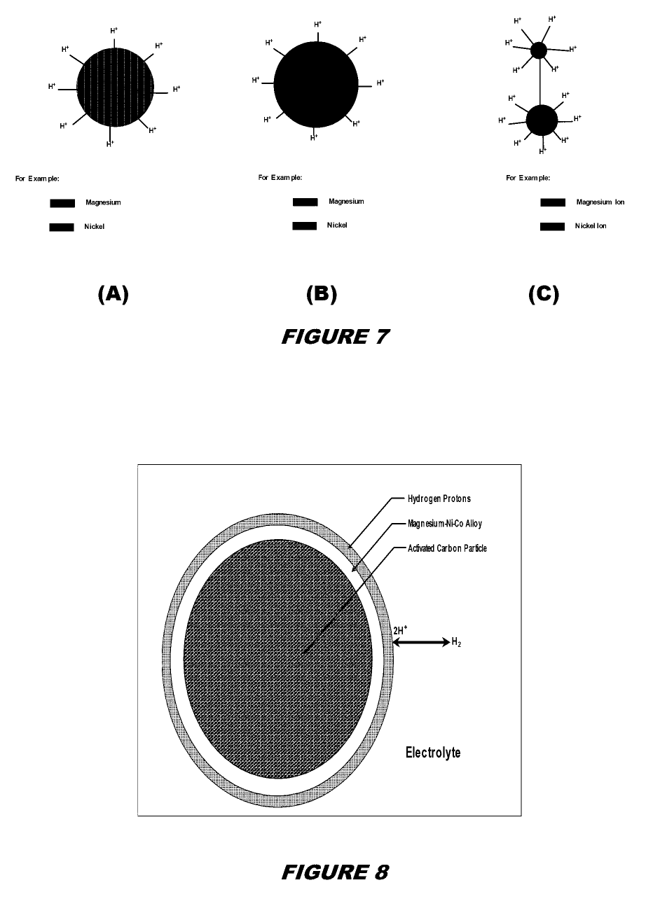

FIG. 7 shows more details of the hydrogen proton carriers. FIG. 7A shows an alloy made of magnesium, nickel and cobalt, FIG. 7B shows a magnesium particle coated with nickel and cobalt, while FIG. 7C shows magnesium, nickel and cobalt ions in a conductive liquid.

FIG. 8 shows a hydrogen proton carrier of a specific construction. It is a very fine activated carbon particle of about 30 to 40 micron size and infused with magnesium, nickel and cobalt in the ratio shown in an autoclave. The particle is then reduced in a hydrogen atmosphere at 1,000° C. for 1 hour. A procedure for producing the particles is as follows:

| 1. | Screen out 2.0 kilogram of activated carbon on 1,400 micron screen. | | | |
|---|---|---|---|---|
| 2. | Dry the material. | | | |
| 3. | Grind in a high speed grinder to talcum powder size. | | | |
| 4. | Feed into an autoclave with the following mixtures | | | |
| | (MgSO₄)₂ = 104.38 × 2 = 208.76 | | | |
| | (NiSO₄).₆ = 138.76 × 0.6 = 83.26 | | | |
| | (CoSO₄)_{.4} = 139.06 × 0.4 = 55.63 | | | |
| 5. | Autoclave is 260H x 150D, say 160 H x 150 D: | | | |
| | Vol = 2,827 mls. | | | |
| 6. | Vol of 2 kg of fine activated carbon = 2000/1.7 = 1,176 mls. | | | |
| 7. | Vol. of Liquid allowed is = 2827 − 1176 = 1,651 mls | | | |
| 8. | Specific Gravity of: | | | |
| | 2MgSO₄•7H₂O | MW = 492.98 | Grams = | 985.96 |
| | NiSO₄•7H₂O | MW = 280.86 | Grams = | 561.72 |
| | CoSO₄•7H₂O | MW = 281.11 | Grams = | 562.22 |
| | | | Total | 2,109.90 |

| | |
|---|---|
| 9. | Vol of liquid is= |
| 10. | Put into autoclave and stir at 200 psig for 30 minutes with Hydrogen. |
| 11. | Depressurise and screen on SS Screen |
| 12. | Dry and then break up into indvidual pieces. |
| 13. | Charge into rotary furnace |
| 14. | Purge with nitrogen. |
| 15 | Reduce with hydrogen at 1000 C. for 30 minutes. |
| 16. | Cool and prepare for use in electrolytic hydrogen storage autoclave. |

This particle can be tested for its capacity to hold hydrogen protons along with the particles described in FIG. 7.

The apparatus to test the proton holding capacity of the proton carriers is shown in FIG. 9 where FIG. 9A shows the storage process. The apparatus can be used to produce hydrogen protons and oxygen ions but FIG. 9 shows the apparatus being used to produce hydrogen protons at the cathode cell and anode cell. In FIG. 9A, electrons are removed from the hydrogen to produce the protons. FIG. 9B shows the hydrogen recovery process where electrons are added to the protons.

The methods and apparatus of the present disclosure allow the storage and recovery of hydrogen at a very small volume. While 4 kilograms of hydrogen has a volume of 1.012×10⁻¹⁴, it is not necessary to go to this extent; it may be sufficient in practice, for example to go to a volume for the 4 kilograms of hydrogen to 1.012×10⁻⁵ that is about ⅓ of the minimum volume.

Applications of the electrolytic storage of hydrogen methods and apparatus of the present disclosure include (but are not limited to):
Storage for renewable energy systems;
Land transport vehicles such as cars;
Water craft such as ships and submarines; and
Aircraft such as jet airliners.

Renewable energy systems such as solar and wind are cyclic and require an efficient storage system to provide useful continuous electric power. FIG. 10 shows the application of the hydrogen proton storage to a solar farm that allows continuous electric power to be delivered over 24 hours and even when there is little sunlight for several days. Solar energy is uneven, being low in the morning, rising to mid-day and declining in the afternoon; the hydrogen proton storage will even out the power delivery according to the load demand and not according to the time of day.

Most car manufacturers already have developed fuel cell cars and buses such as Mercedes Benz, Toyota, Ford, GM, Hyundai and others. What they require to make these vehicles practical is an efficient hydrogen storage system according to the present disclosure and the efficient fuel cell such as the non-diffusion hydrogen fuel cell described in U.S. Pat. No. 6,475,653. FIG. 11 shows a concept car using the hydrogen storage of the present disclosure and the non-diffusion hydrogen fuel cell. Hydrogen comes from the storage system while oxygen is accessed from the atmosphere.

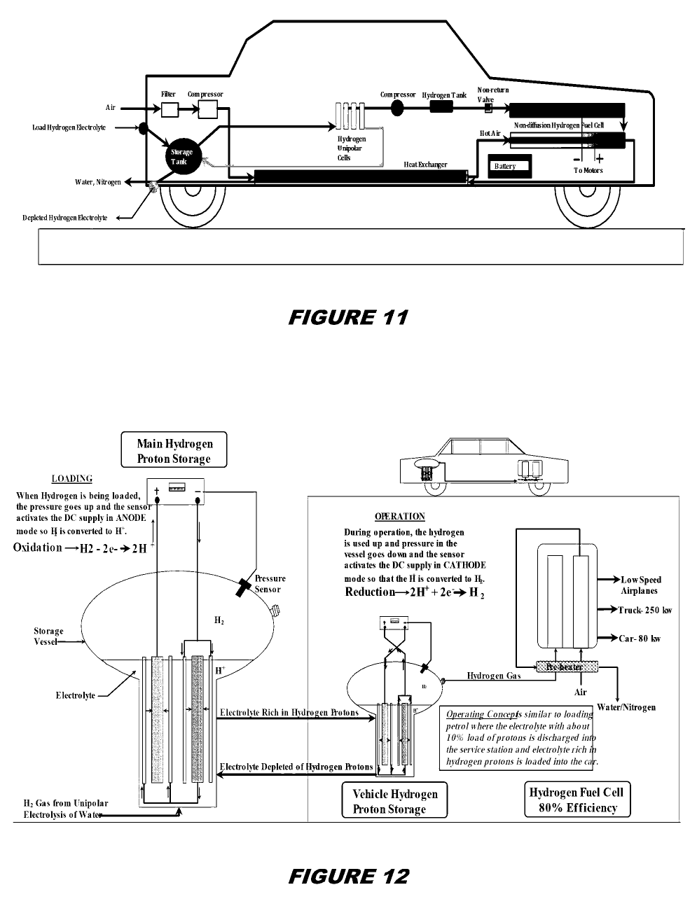

FIG. 12 shows the operation of a fuel cell vehicle in loading the hydrogen ion liquid where the hydrogen is stored as protons. The hydrogen ion liquid is prepared at the service point and a car drops its depleted hydrogen ion liquid into the service point and then takes in fully charged hydrogen ion liquid. This hydrogen ion liquid may last for about 1 to 3 months.

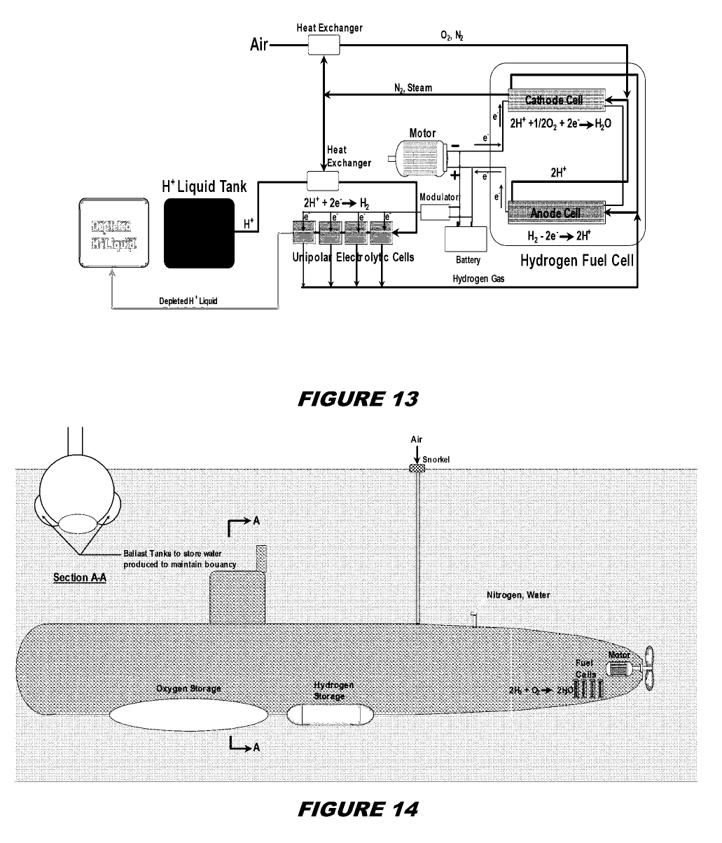

FIG. 13 shows more technical details of the operation of the hydrogen ion liquid and how electrons are added through the unipolar electrolysis. The depleted hydrogen ion liquid may be delivered to the same tank or to another tank. Oxygen for the fuel cell is accessed from the atmosphere. The efficiency of the hydrogen system can be calculated based on 80% efficiency for the fuel cell and a conservative voltage of 0.3 volts for the unipolar electrolysis of the hydrogen ion liquid, shown in the Table 3.

TABLE 3

| Basis: | |
|---|---|
| 1. H₂ + 1/2O₂ fi H₂O H_{O}, KJ/mol | 286 |
| 2. 1 Faraday, ampere-seconds (Coulombs) | 96,484 |
| 3. 1 kilojoule, joules | 1,000 |
| 4. 1 kilo Watt-hour, joules | 3,600,700.00 |
| 5. 1 kilowatt-hour = Calories | 860,420.65 |
| 6. 1 calorie, joules | 4.18 |
| 7. 1 kwh, joules | 3,600,000 |
| 8. Hydrogen Fuel Cell Efficiency, % | 80 |
| Calculations: | |
| 9. Input kw into the Hydrogen Fuel cell, kw | 85.00 |
| 10. For 1 hour operation, calories required, cals | 73,135,755.25 |
| 11. Hydrogen mole produces calories | 68,421.05 |
| 12. Moles of hydrogen required per hour, moles | 1,068.91 |
| 13. Grams of hydrogen required per hour, grams | 2,137.81 |
| 14. Ampere seconds required, ampere seconds | 206,264,883.05 |
| 15. Ampere required, ampere | 57,295.80 |
| 16. Current in Unipolar Mode, ampere hours | 28,647.90 |
| 17. KW if voltage is assumed as 0.3 volts | 8.59 |
| 18. Output Rating of Hydrogen fuel Cell, kw | 59.41 |
| 19. Nett Efficiency, % | 70 |

This nett efficiency that includes the fuel cell efficiency and the energy to reclaim the hydrogen from storage is very good compared to the current systems which may be about less than half the efficiency of the present disclosure.

Water vessels including pleasure and military vessels may be supplied with the hydrogen ion liquid and the oxygen is accessed from the atmosphere. It is different with submarines where part of the air may be accessed from the atmosphere but the submarine must carry liquid oxygen for use during submerged cruising. FIG. 14 is a diagram of a submarine fitted with the non-diffusion hydrogen fuel cell to power the motors of the submarine and provided with hydrogen ion liquid. During surface cruising, the submarine may use the hydrogen ion liquid and access oxygen from the atmosphere. An important feature of the hydrogen fuel cell powered submarine over a diesel power submarine is the quietness and ease of operation. During submerged cruising, the submarine must rely on the liquid oxygen and the hydrogen ion for propulsion. Table 4 shows the difference in performance of the diesel powered Collins Class submarine.

TABLE 4

| Collins Class Submarine | Collins Class | H₂-Fuel Cell |
|---|---|---|
| Range, nautical miles | 11,000 | 11,000 |
| Speed, knots | 21 | 21 |
| Operational time, hours | 524 | 524 |
| Power, 3 × 1,400 kw | 4,200 | 4,200 |
| Kilowatt-hours Operation, kwh | | 2,200,000 |
| Watt-hours | | 2,200,000,000 |
| No. of Kilojoules | | 7,921,540,000 |
| No. of Reactions | | 13,848,846 |
| Tonnes of Oxygen, tonnes | | 443.16 |
| Tonnes Hydrogen, tonnes | | 55.40 |
| To double the range: | | |
| Liquid Oxygen, tonnes | | 886 |
| Hydrogen, tonnes | | 111 |
| Range, Submerged—Nautical Miles | 480 | 11,000 |

The hydrogen fuel cell submarine is not only quiet and reliable but its submerged range is 11,000 nautical miles against 480 nautical miles for the diesel-battery submarine.

Jet airliners are a major cause of pollution not only for the carbon dioxide they produce but also more toxic materials such as nitrous oxide and unburnt hydrocarbons.

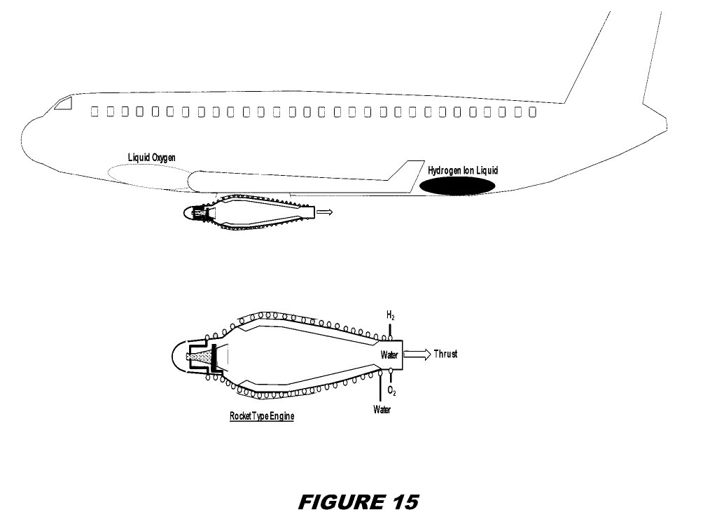

FIG. 15 is a diagram of an airliner using the hydrogen storage of the present disclosure. By using liquid oxygen and hydrogen only, there are no harmful products and the waste of the operation is only water even though the temperature of the rocket engine is white heat. The advantage of this is that there are no moving parts and the rocket engine is fully enclosed except for the exhaust. Aside from an easy retro-fit to existing jet airliners, the resulting airliner will be much safer and more economical to operate.

Table 5 shows the practicality of a rocket airliner using methods and apparatus of the present disclosure. It is based on a rocket airliner travelling from Melbourne to London a distance of 16,000 kilometers in one flight.

TABLE 5

| Range of a Jet Airliner—Boeing 787 | H₂ Airliner |
|---|---|
| Energy Capacity-, kw | 72,000 |
| Distance Melbourne to London, km | 16,000 |
| Average speed of a 787 Dreamliner, kph | 954 |
| 2H₂ + O₂ fi 2H₂O, heat of reaction, kilojoules | 572 |
| 1 Watt-hour, joules | 3,601 |
| Operating Hours of Boeing 787 Melbourne to | 17 |
| London, hrs | |
| 787 Operating for 30 hours, kwh | 1,207,547 |
| Watt-hours | 1,207,547,170 |
| No. of Kilojoules | 4,348,015,094 |
| No. of 2H₂ + O₂ reactions | 7,601,425 |
| Tonnes of O₂, tonnes | 243.25 |
| Tonnes of Hydrogen, tonnes | 30.41 |

Air travel in the future will be safer, more convenient, and cheaper plus the immeasurable benefit of using a non-carbon fuel.

The foregoing calculations are based on assumptions that can be confirmed by pilot plant or commercial plant tests.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A process for storing hydrogen as a proton, the process comprising:
providing an electrolytic cell comprising an anode cell having an anode electrode and a cathode cell having a cathode electrode, the anode cell and the cathode cell being electrically connected via a diaphragm or electronic membrane between the anode cell and the cathode cell or via an anode solution electrode in the anode cell connected by an external conductor to a cathode solution electrode in the cathode cell;
feeding hydrogen to the anode cell and applying a DC current from a DC power source to the anode electrode to generate hydrogen protons from the hydrogen gas in the anode cell;
storing the generated hydrogen protons in a hydrogen proton storage medium; and
feeding oxygen to the cathode cell and applying a DC current from the DC power source to the cathode electrode to generate oxygen anions from the oxygen gas in the cathode cell and storing the generated oxygen anions, or
feeding hydrogen to the cathode cell and applying a DC current from the DC power source to the cathode solution electrode to generate hydrogen protons from the hydrogen gas in the cathode cell and storing the generated hydrogen protons in a hydrogen proton storage medium.

2. The process according to claim 1 wherein the hydrogen proton storage medium is selected from one or more of the group consisting of: an electrode with high surface area; and a conducting aqueous or non-aqueous conductive liquid that contains hydrogen proton receptors comprising metal ions, particles of metal alloys, a metal coated with another metal, or an activated carbon particle infused with metal oxides and reduced by hydrogen.

3. The process according to claim 1 further comprising generating hydrogen gas from the hydrogen protons by changing the electrical circuit so that electrons are added to the anode and/or the cathode under conditions to form hydrogen gas from the hydrogen protons.

4. The process according to claim 3, further comprising feeding the hydrogen gas produced to a non-diffusion hydrogen fuel cell to produce electricity.

5. The process according to claim 1, wherein the hydrogen that is fed to the cell(s) is produced by unipolar electrolysis of water.

6. An apparatus to store hydrogen as a proton, the apparatus comprising a diaphragm-less anode cell to produce hydrogen protons from hydrogen wherein the anode cell has an anode electrode and an anode solution electrode, the anode electrode being connected to a DC power source, a diaphragm-less cathode cell to produce hydrogen protons from hydrogen wherein the cathode cell has a cathode electrode and a cathode solution electrode, the cathode being connected to a DC power source, the anode solution electrode connected to the cathode solution electrode by an external conductor, means to apply a DC current from the DC power source to the anode electrode and the cathode electrode to produce hydrogen protons, and a hydrogen proton storage medium for storing the generated hydrogen protons.

7. The apparatus according to claim 6, wherein the hydrogen proton storage medium is selected from one or more of the group consisting of: an electrode with high surface area; and a conducting aqueous or non-aqueous conductive liquid that contains hydrogen proton receptors comprising metal ions, particles of metal alloys, a metal coated with another metal, or an activated carbon particle infused with metal oxides and reduced by hydrogen.

8. The apparatus according to claim 6, further comprising means for generating hydrogen gas from the hydrogen protons by changing the electrical circuit so that electrons are added to the anode and the cathode under conditions to form hydrogen gas from the hydrogen protons.

9. The apparatus according to claim 8, further comprising a non-diffusion hydrogen fuel cell configured to produce electricity from the hydrogen gas produced.

10. The apparatus according to claim 6, further comprising a unipolar water electrolysis apparatus configured to produce hydrogen to be fed to the cell(s).
